(19) United States
(12) Patent Application Publication
(10) Pub. No.: US 2008/0049697 A1
(43) Pub. Date: Feb. 28, 2008

(54) Method and Radio Communication System for Transmitting User Information as a Service to Several User Stations

(76) Inventors: Volker Breuer, Botzow (DE); Norbert Kroth, Potsdam (DE); Marcus Purat, Berlin (DE); Dave Randall, Hampshire (GB)

Correspondence Address: STAAS & HALSEY LLP, SUITE 700, 1201 NEW YORK AVENUE, N.W., WASHINGTON, DC, 20005, US

(21) Appl. No.: 10/513,689

(22) PCT Filed: May 6, 2003
(86) PCT No.: PCT/EP03/04752

§ 371 Date: May 4, 2007

(30) Foreign Application Priority Data
May 6, 2002 (EP) 02010087.1

(51) Int. Cl. H04Q 7/36

(52) U.S. Cl. 370/341

(57) ABSTRACT

A method and a radio communication system transmit user information as a service to several user stations in a radio communication system comprising at least one base station and user stations which are connected to each other via a radio communication interface. The base station signals to the user stations using the at least one service via a group control channel, radio resource information on at least one traffic channel via which the user information of the at least one service is transmitted to the user stations.

### CROSS REFERENCE TO RELATED APPLICATIONS

This application is based on and hereby claims priority to PCT Application No. PCT/EP03/04752 filed on May 6, 2003 and European Application No. 02010087.1 filed on May 6, 2002, the contents of which are hereby incorporated by reference.

### BACKGROUND OF THE INVENTION

The invention relates to a method for transmitting user information in a radio communication system comprising at least one radio network controller device, at least one base station and at least one user station.

Communication systems are becoming increasingly important not only in the economic area but also in the private domain. Strenuous efforts are being made to link cable-connected communication systems to radio communication systems. The resulting hybrid communication systems lead to an increase in the number of services available, but they also enable greater flexibility on the communication side. Thus, for example, devices are being developed which can use different systems (multi-homing).

Great importance is attached here to the radio communication systems as a result of the mobility allowed to users.

In radio communication systems, information (for example voice, image information, video information, SMS [Short Message Service] or other data) is transmitted with the aid of electromagnetic waves via a radio interface between sending and receiving station (base station and user station). The electromagnetic waves are emitted here at carrier frequencies which lie in the frequency band provided for the respective system.

Frequencies at 900, 1800 and 1900 MHz are used for the existing GSM mobile radio system (GSM =Global System for Mobile Communication). These systems essentially transmit voice, fax and SMS messages (SMS=Short Message Service) as well as digital data.

Frequencies in the frequency band around approximately 2000 MHz are provided for future mobile radio systems using CDMA or TD/CDMA transmission methods such as, for example, UMTS (Universal Mobile Telecommunication System) or other third-generation systems. These third-generation systems are being developed with the aims of worldwide radio coverage, a vast offering of data transmission services and, most importantly, flexible management of the capacity of the radio interface, which is the interface with the fewest resources in radio communication systems. With the radio communication systems the objective is to enable a user station to send and/or receive a large volume of data at a high data rate as necessary, mainly through flexible management of the radio interface.

Access by stations to the shared radio resources of the transmission medium, such as, for example, time, frequency, power or space, is controlled in these radio communication systems by multiple access (MA) methods.

With Time Division Multiple Access (TDMA) methods, each transmit and receive frequency band is subdivided into time slots, with one or more cyclically repeated time slots being allocated to the stations. With TDMA, the radio resource ‘time’ is separated on a station-specific basis.

With Frequency Division Multiple Access (FDMA) methods, the entire frequency range is subdivided into narrowband channels, with one or more narrowband frequency bands being allocated to the stations. With FDMA, the radio resource ‘frequency’ is separated on a station-specific basis.

With Code Division Multiple Access (CDMA) methods, a spread-spectrum code which has a large number of individual bits or “chips” is used to encode the power/information to be transmitted on a station-specific basis, as a result of which the power to be transmitted is spread randomly based on the code over a large frequency range. The spread-spectrum codes used by different stations within a cell/base station are reciprocally orthogonal or essentially orthogonal with respect to each other in each case, which enables a receiver to recognize the signal power allocated to itself and suppress other signals. With CDMA, the radio resource ‘power’ is separated on a station-specific basis by spread-spectrum codes.

With Orthogonal Frequency Division Multiplex (OFDM) transmission methods, the data is transmitted over wideband channels, with the frequency band being divided into equidistant, orthogonal subcarriers so that the simultaneous phase shift of the subcarriers generates a two-dimensional data flow in the time-frequency domain. With OFDM, the radio resource ‘frequency’ is separated on a station-specific basis by orthogonal subcarriers. The combined data symbols transmitted during a time unit on the orthogonal subcarriers are referred to as OFDM symbols.

Multiple access methods can be combined. Thus, many radio communication systems use a combination of the TDMA and FDMA methods, with each narrowband frequency band being subdivided into time slots.

For the UMTS mobile radio system referred to, a distinction is made between what is termed FDD (Frequency Division Duplex) mode and a TDD (Time Division Duplex) mode. The TDD mode is characterized in particular by the fact that a common frequency band is used for the signal transmission both in the uplink (UL) direction and in the downlink (DL) direction, while the FDD mode uses a different frequency band for each of the two transmission directions.

In second- and/or third-generation radio communication connections, information can be transmitted over circuit-switched (CS) or packet-switched (PS) routes.

The connection between the at least one base station and the at least one user station is established via a radio communication interface. In this case the base station can serve a plurality of radio cells.

Typically, the at least one base station and one radio network controller (RNC) device are components of a base station subsystem, or radio network subsystem (RNS). A radio communication system generally comprises a plurality of base station subsystems which are connected to a core network (CN). In this case the radio network controller of the base station subsystem is connected to an access device (SGSN=Serving GPRS Support Node) of the core network.

Data that is made available to a plurality of users is transmitted in radio communication systems in addition to individual user information elements. Such user information includes, for example, video streams or other broadcast and/or multicast information. The services for the transmission of user information which are provided, not just on an individual basis for a single user, but for a plurality of users, are combined under the term MBMS (Multimedia Broadcast/Multicast Service).

The services for the transmission of user information which are provided, not just on an individual basis for a single user, but for a plurality of users, are combined under the term MBMS (Multimedia Broadcast/Multicast Service).

Services for the transmission of broadcast and multicast information can make use of different data rates.

In current mobile radio networks (e.g. UTRAN) only a broadcast service operating at a maximum data rate (e.g. 32 kbps) can be provided, which service is transmitted via one channel of the radio network. The multiplexing of the service takes place in the core network (e.g. CBC (Common Broadcast Channel)) on the basis of message type identifiers. In this case the radio resource which is used for the broadcast service is known to the user station through the reading of the system information which is transmitted as broadcast information across the entire radio cell to all user stations.

The networks are thus faced with new requirements for facilities which are able above all to guarantee high data rates (>64 kbps) and allow dynamic allocation of the radio network resources to individual broadcast and/or multicast services. It should also be possible to transmit different multimedia services (text, audio, video, etc.) in parallel to the users over point-to-multipoint connections. The different MBMS (Multimedia Broadcast/Multicast Service) services are provided as separate data streams by the core network. The radio network is expected to multiplex the data on one radio channel or on multiple radio channels. In principle all the multiple access methods can be used here individually or in combination.

US 2002/051442 A1 discloses a method for transmitting and receiving a broadcast message in a mobile communication system.

If the transmission is to take place at a higher data rate, the broadcast message is transmitted through a traffic channel instead of via the broadcast channel.

### SUMMARY OF THE INVENTION

One possible object of the invention is therefore to disclose a method and a radio communication system of the type mentioned at the beginning which fulfill these requirements individually or in their entirety.

The inventors propose that the base station signals via a group control channel to the user stations using the at least one service radio resource information relating to at least one traffic channel via which the user information of the at least one service is transmitted to the user stations.

Exceptionally large dynamics with regard to the management of the radio resources can be guaranteed as a result of transmitting the signaling information relating to the MBMS services on the group control channel and transmitting the actual user information on traffic channels. In this way, among other things, the different specific quality of service (QoS) requirements of the individual MBMS services can also be taken into account and ensured without major difficulties.

The resources used for the group control channel must be known potentially to all the user stations in the radio cell. This information can be provided over broadcast channels for example as part of the system information. The group control channel can be referred to, for example, as an MBMS group control channel. In principle any shared channel of a radio cell can be used as a group control channel.

Information about just one service or also preferably about different services which can be received in a radio cell can be transmitted in the group control channel. At a minimum, all user stations actively using a broadcast or multicast service receive the necessary information via the group control channel.

The radio resource information relating to the at least one traffic channel and signaled via the group control channel can comprise different information specifically. In any event information relating to a traffic channel (this can relate, for example, to the channel ID, the channelization code, the spreading factor or the like) or relating to multiple traffic channels must be transmitted to the user stations.

The base station can transmit information which relates to the identification of the at least one service (MBMS Service ID) via the group control channel.

The base station can also transmit information which relates to the start time of the transmission of the at least one service in the at least one traffic channel via the group control channel.

Furthermore the base station can signal information which relates to the transmission duration of the service in the at least one traffic channel via the group control channel.

The base station can transmit information which relates to the periodicity of the transmission of the service in the at least one traffic channel via the group control channel.

In principle the base station can transmit information via the group control channel continuously. This also implies that it is possible for data to be transmitted in sequential radio frames to cater for the time division multiple access method (time division multiplexing).

However, particular advantages result if the base station only transmits information via the group control channel intermittently. This channel can then also be used for other information, since as a rule a complete seizure of the channel resource of the group control channel for the signaling of the MBMS information is not used. As a result of this measure the dynamic radio resource management can receive additional support.

In the event that the base station transmits information via the group control channel only occasionally, it is particularly useful if the base station transmits information which relates to the time of the next transmission relating to at least one service in the group control channel via the group control channel. In this way the user stations actively taking part in an MBMS service know when signaling information related to an MBMS service or, as the case may be, MBMS services is transmitted in the radio cell.

In the embodiment, the information transmitted via the group control channel is transmitted in a resource allocation scheme (RAS) within a radio frame. A resource allocation scheme can, for example, include:
MBMS service ID, channel ID,
Channelization code, spreading factor,
Start time, duration, periodicity,
Instant in time of the transmission of the next resource allocation scheme.

A resource allocation scheme can also be transmitted on the group control channel within an explicit signaling message. A new resource allocation scheme can signal a completely new configuration. Alternatively, however, changes to one or more specific MBMS services can be transmitted in an existing configuration or an already transmitted resource allocation scheme can even be retransmitted.

In a further development, different services can be mapped to separate traffic channels. However, it is also possible that different services are time-multiplexed on one traffic channel or on multiple traffic channels. Finally, these two cited possibilities can also be combined.

In the radio communication system the base station signals over a group control channel to the user stations using the at least one service, radio resource information relating to at least one traffic channel via which the user information of the at least one service is transmitted to the user stations.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1: shows a schematic representation of the transmission in the group control channel and on multiple traffic channels according to one embodiment of the invention,

FIG. 2: shows a schematic representation of the transmission between a radio network controller, base stations and user stations according to one embodiment of the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

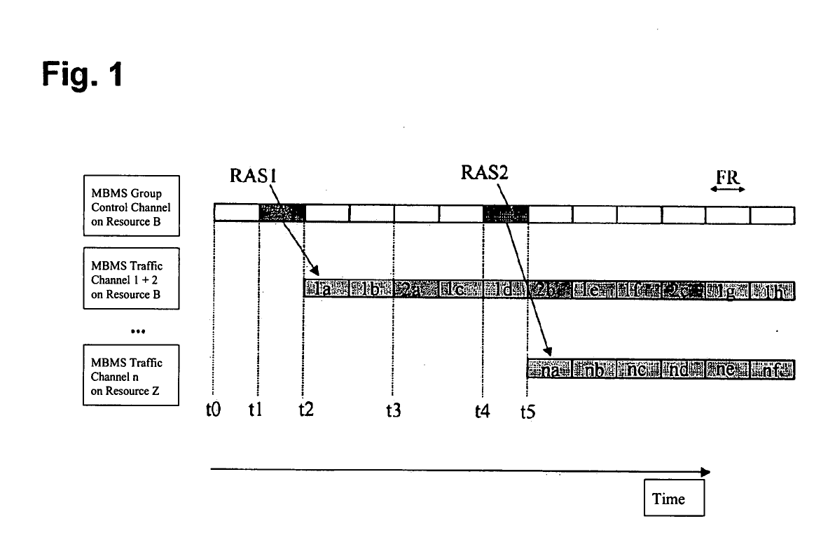

In FIG. 1 the upper part of the diagram shows an example of a transmission within the group control channel (MBMS group control channel) on a radio resource A of an arbitrary non-time-based multiple access method (e.g. frequency division, code division) over time. Resource allocation schemes RAS1 and RAS2 are each transmitted in a radio frame of length FR at the instants in time t1 and t4 respectively.

In the first resource allocation scheme RAS1 it is specified that the traffic channel 1 (MBMS Traffic Channel 1) on a second radio resource B carries an MBMS service 1 which starts at time t2 and has a duration of two radio frames (1a, 1b; 1c, 1d; 1e, 1f; 1g, 1h) of length FR and a periodicity of one radio frame. Traffic channel 2 (MBMS Traffic Channel 2) on the second radio resource B additionally carries, in accordance with the signaling in the resource allocation scheme RAS1, an MBMS service 2 which starts at time t3 and has a duration of one radio frame (2a; 2b; 2c) of length FR and a periodicity of two radio frames.

In the second resource allocation scheme RAS2 it is signaled that the traffic channel n (MBMS Traffic Channel n) on a second radio resource Z carries an MBMS service n which starts at time t5. MBMS service n has a duration of one radio frame (na; nb; nc; nd; ne; nf) of length FR and a periodicity of one radio frame.

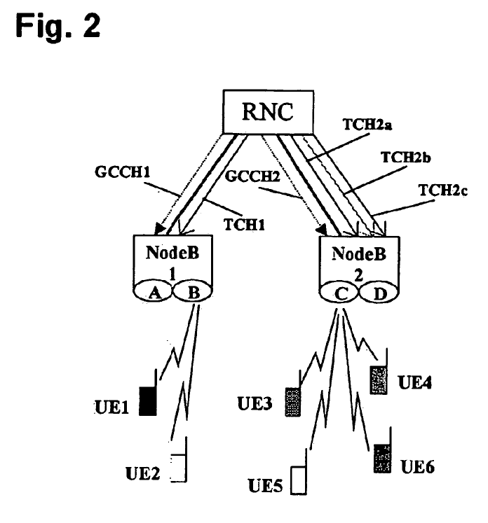

FIG. 2 shows a schematic representation of the transmission between a radio network controller RNC, two base stations NodeB1 and NodeB2 and mobile user stations UE1, UE2, UE3, UE4, UE5 and UE6.

The radio network controller RNC is connected to the two base stations NodeB1 and NodeB2. Base station NodeB1 serves the radio cells A and B, and base station NodeB2, the radio cells C and D. The user stations UE1 and UE2 are located in the radio cell B. The user stations UE3, UE4, UE5 and UE6 belong to the radio cell C.

In the radio cell B, an MBMS service which is signaled via the group control channel GCCH1 by the radio network controller RNC via the radio cell B of the base station NodeB1 via the radio communication interface and is transmitted via the traffic channel TCH1, is received by the mobile user station UE1. User station UE2 receives no MBMS service.

In the radio cell C, three MBMS services which are signaled via the group control channel GCCH2 by the radio network controller RNC via the radio cell C of the base station NodeB2 via the radio communication interface and are transmitted via the traffic channels TCH2a, TCH2b and TCH2c, are received by the mobile user stations UE3, UE4 and UE6. The user station UE3 receives the services transmitted via the traffic channels TCH2a and TCH2c. The user station UE4 receives the service transmitted via the traffic channel TCH2b. The user station UE6 receives the service transmitted via the traffic channel TCH2c. User station UE5 receives no MBMS service.

The invention has been described in detail with particular reference to preferred embodiments thereof and examples, but it will be understood that variations and modifications can be effected within the spirit and scope of the invention covered by the claims which may include the phrase “at least one of A, B and C” or a similar phrase as an alternative expression that means one or more of A, B and C may be used, contrary to the holding in Superguide v. DIRECTV, 69 USPQ2d 1865 (Fed. Cir. 2004).

1-13. (canceled)

14. A method for transmitting user information as a service to multiple user stations in a radio communication system having a base station connected to the user stations via a radio communication interface, comprising:
sending signals from the base station via a group control channel to the user stations, the signals containing radio resource information relating to a traffic channel via which the user information is transmitted to the user stations; and
transmitting duration information from the base station, via the group control channel, the duration information relating to a transmission duration of the user information on the traffic channel.

15. The method according to claim 14, wherein the base station transmits, via the group control channel, information which identifies the service to which the user information relates.

16. The method according to claim 14, wherein the base station transmits, via the group control channel, information which identifies a start time for transmission of the user information on the traffic channel.

17. The method according to claim 14, wherein the base station transmits information continuously over the group control channel.

18. The method according to claim 14, wherein the base station transmits information intermittently over the group control channel.

19. The method according to claim 14, wherein the information transmitted via the group control channel is transmitted in a resource allocation scheme within a radio frame.

20. The method according to claim 14, wherein different services are mapped to separate traffic channels.

21. The method according to claim 14, wherein different services are time-multiplexed on one or more traffic channels.

22. A method for transmitting user information as a service to multiple user stations in a radio communication system having a base station connected to the user stations via a radio communication interface, comprising:
sending signals from the base station via a group control channel to the user stations, the signals containing radio resource information relating to a traffic channel via which the user information is transmitted to the user stations ; and
transmitting periodicity information from the base station, via the group control channel, the periodicity information relating to the periodicity at which the user information is transmitted on the traffic channel.

23. The method according to claim 22, wherein the base station transmits, via the group control channel, information which identifies the service to which the user information relates.

24. The method according to claim 22, wherein the base station transmits, via the group control channel, information which identifies a start time for transmission of the user information on the traffic channel.

25. The method according to claim 22, wherein the base station transmits information continuously over the group control channel.

26. The method according to claim 22, wherein the base station transmits information intermittently over the group control channel.

27. The method according to claim 22, wherein the information transmitted via the group control channel is transmitted in a resource allocation scheme within a radio frame.

28. The method according to claim 22, wherein different services are mapped to separate traffic channels.

29. The method according to claim 22, wherein different services are time-multiplexed on one or more traffic channels.

30. A method for transmitting user information as a service to multiple user stations in a radio communication system having a base station connected to the user stations via a radio communication interface, comprising:
sending signals from the base station via a group control channel to the user stations, the signals containing radio resource information relating to a traffic channel via which the user information is transmitted to the user stations ; and
transmitting time information from the base station, via the group control channel, the time information relating to time of next transmission of the radio resource information on the group control channel.

31. The method according to claim 30, wherein the base station transmits, via the group control channel, information which identifies the service to which the user information relates.

32. The method according to claim 30, wherein the base station transmits, via the group control channel, information which identifies a start time for transmission of the user information on the traffic channel.

33. The method according to claim 30, wherein the base station transmits information continuously over the group control channel.

34. The method according to claim 30, wherein the base station transmits information intermittently over the group control channel.

35. The method according to claim 30, wherein the information transmitted via the group control channel is transmitted in a resource allocation scheme within a radio frame.

36. The method according to claim 30, wherein different services are mapped to separate traffic channels.

37. The method according to claim 30, wherein different services are time-multiplexed on one or more traffic channels.

38. A radio communication system for transmitting user information as a service to multiple user stations, comprising:
a base station connected to the user interfaces via a radio communication interface;
a signaling unit provided in the base station to signal radio resource information to the user stations via a group control channel, the radio resource information relating to a traffic channel via which the user information is transmitted to the user stations ; and
a transmission unit to transmit from the base station, via the group control channel, information which relates to a transmission duration of the user information on the traffic channel.

39. A radio communication system for transmitting user information as a service to multiple user stations, comprising:
a base station connected to the user interfaces via a radio communication interface;
a signaling unit provided in the base station to signal radio resource information to the user stations via a group control channel, the radio resource information relating to a traffic channel via which the user information is transmitted to the user stations ; and
a transmission unit to transmit from the base station, via the group control channel, information which relates to a periodicity of transmission of the user information on the traffic channel.

40. A radio communication system for transmitting user information as a service to multiple user stations, comprising:
a base station connected to the user interfaces via a radio communication interface;
a signaling unit provided in the base station to signal radio resource information to the user stations via a group control channel, the radio resource information relating to a traffic channel via which the user information is transmitted to the user stations ; and
a transmission unit to transmit from the base station, via the group control channel, information which relates to a time of next transmission of the radio resource information on the group control channel.
